(19) United States
(12) Patent Application Publication
(10) Pub. No.: US 2012/0290468 A1
(43) Pub. Date: Nov. 15, 2012

(54) Method and apparatus for secure payment using a network-connectable device

(76) Inventors: David S. Benco, Winfield, IL (US); Jose de Francisco Lopez, Aurora, IL (US)

(21) Appl. No.: 13/068,555

(22) Filed: May 13, 2011

(51) Int. Cl. G06Q 40/00

(52) U.S. Cl. 705/39

(57) ABSTRACT

An apparatus and method for completing a payment transaction using a network-connectable device is disclosed. When a payer initiates a payment transaction to a vendor using the network connectable device, a unique identifier and current geolocation of the network-connectable device are sent to a payment server together with a server payment transaction message containing information about the payment transaction. The payment server compares the geolocation with the vendor location and one or more predetermined locations associated with the payer, for example, a home or workplace. Upon a successful comparison, the payment retrieves a third party payment record from a mapping database and uses it to complete the payment transaction with a third party payment processing system.

### TECHNICAL FIELD

This invention relates to electronic payment systems.

### BACKGROUND

The credit card industry is very successful and well-established worldwide. However, despite recent advances in credit card technology, such as magnetic strip encoding and the 3-digit Verification Code on the back of the card, credit card fraud continues to increase.

Therefore, there is a need for a payment system that provides increased security when paying for goods and services.

### SUMMARY

A system and method for using a mobile phone or other network-connectable device to pay for goods and services is disclosed. Several safeguards are provided to ensure a secure transaction, including entry of a PIN number, a check of the geolocation of the device and additional verification if the geolocation check shows that the device is not located at a vendor site or a predefined safe zone, for example, the payer's home or work location. After authentication, a unique identifier, for example, a mobile phone number or a Media Access Control (MAC) address is associated with a credit card number, PayPal account or other payment method and the payment transaction is then processed.

In one embodiment, there is provided an apparatus for completing a payment transaction with a vendor by using a network-connectable device. The apparatus comprises a payment server which receives a unique identifier of the network-connectable device, information about the payment transaction and a current geolocation of the device. The apparatus further comprises a mapping database which maps at least one unique identifier of a network-connectable device to a third party payment record. The payment server compares the current geolocation of the network-connectable device to at least one of a location of the vendor as well as other predetermined locations. If the comparison is successful, the payment server accesses a third party payment record corresponding to the unique identifier of the network-connectable device being used for the payment from the mapping database and completes the payment transaction by communicating with a third party payment processing system. If the comparison is not successful, the payment server requests additional verification.

In another embodiment, there is provided an apparatus for completing a payment transaction by using a network-connectable device executing an application. The application receives a vendor payment request message and prepares a server payment transaction message. The apparatus further includes a payment server for receiving the server payment transaction message, a unique identifier associated with the network-connectable device and a current geolocation of the device. The apparatus further comprises a mapping database for mapping at least one unique identifier to at least one third party payment record. The payment server compares the current geolocation of the network-connectable device to at least one of a location of the vendor as well as predetermined locations. If the comparison is successful, the payment server completes the payment transaction by retrieving a third party payment record from the mapping database that corresponds to the unique identifier received from the network-connectable device and communicating with a third party payment processing system. The payment server then provides a payment transaction result to the network-connectable device and the vendor.

In another embodiment, there is provided a method for completing a payment transaction using a network-connectable device. The method comprises steps of receiving, by a payment server, a unique identifier of the network-connectable device, a geolocation of the network-connectable device and a server transaction message comprising at least information representing a transaction between the vendor and a payer using the network-connectable device; associating the unique identifier with a third party payment record stored in a database operatively coupled to the payment server; comparing the geolocation of the network-connectable device to at least one of a location of the vendor and a list of predetermined locations associated with the payer; and completing the payment transaction, in response to a positive comparison, by interfacing with a third party payment processing system.

In another embodiment, there is provided a method of completing a payment transaction using a network-connectable device executing an application. The method comprises steps of receiving a vendor transaction message comprising at least information representing a transaction between the vendor and a payer using the network-connectable device; comparing a geolocation of the network-connectable device to at least one of a vendor location and predetermined locations associated with a payer; if the comparison is successful, completing the payment transaction by interfacing with a third party payment processing system; and, if the comparison is not successful, requesting additional verification from the payer before completing the transaction.

Some embodiments of any of the above apparatus or methods further include a network-based geolocation server for providing a geolocation of the network-connectable device if the device does not have geolocation capability.

Some embodiments of any of the above apparatus or methods request verification from a user if the comparison of a geolocation is not successful.

In some embodiments of any of the above apparatus or methods, the predetermined locations can include, for example, a home or workplace of a payer using a network-connectable device.

In some embodiments of any of the above apparatus or methods the third party payment record comprises information about at least one of a credit card, a debit card, a PayPal account, and a phone service account.

Some embodiments of any of the above apparatus or methods further include a vendor application server, located locally at the vendor or available over the network, to generate a vendor payment request.

Some embodiments of any of the above apparatus or methods further include a vendor payment request message that comprises a two-dimensional code and the payment application is launched by scanning the two-dimensional code.

Some embodiments of any of the above apparatus or methods further include a vendor payment request message that is sent using a multi-media message service or short message service (MMS or SMS).

Some embodiments of any of the above apparatus or methods further include an application being executed by the network-connectable device. The application may be stored on the device or hosted on a server connected to the network.

Some embodiments of any of the above apparatus or methods further include prompting the payer using the network-connectable device to enter a personal identification number (PIN).

### DESCRIPTION OF THE DRAWINGS

Features of example embodiments will become apparent from the description, the claims, and the accompanying drawings in which:

FIG. 1 is a representation of one implementation of a processing system.

FIG. 2 is a representation of additional details of the processing system of FIG. 1.

FIGS. 3A and 3B are a representation of the first half of a flowchart showing the operation of the apparatus of FIG. 1.

FIG. 4 is a representation of the second half of a flowchart showing the operation of the apparatus of FIG. 1

FIG. 5 is a representation of a network-connectable device executing a payment application.

FIGS. 6A and 6B is a representation of a flowchart showing the operation of the network-connectable device of FIG. 5.

### DETAILED DESCRIPTION

This detailed description discusses embodiments in terms of a mobile phone, which is one example of a network-connectable device. It should be understood that all of the following embodiments would work with any network-connectable device, substituting a unique address, such as a Media Access Control (MAC) address or Ethernet Hardware Address (EHA), for the mobile phone number.

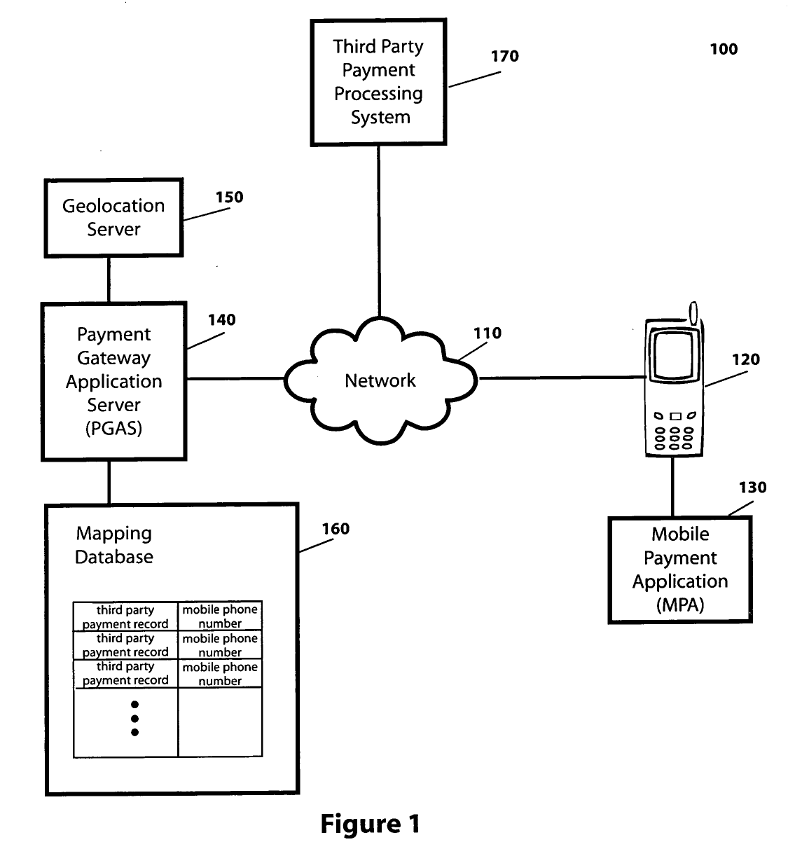

Turning to FIG. 1, an apparatus 100 in one embodiment comprises a client-server system. In such a system, servers provide software applications for clients that access the applications over a network 110 using a variety of different communication protocols, for example HTTP and XML. Clients, for example, mobile phone 120, can both execute applications which have been downloaded to the phone, as well as use a web browser that acts as an interface for an application being hosted on a server. The operations performed to accomplish a particular application can be flexibly distributed between a client and a server. For the purposes of this specification, a web browser operating on a mobile phone is considered a type of application.

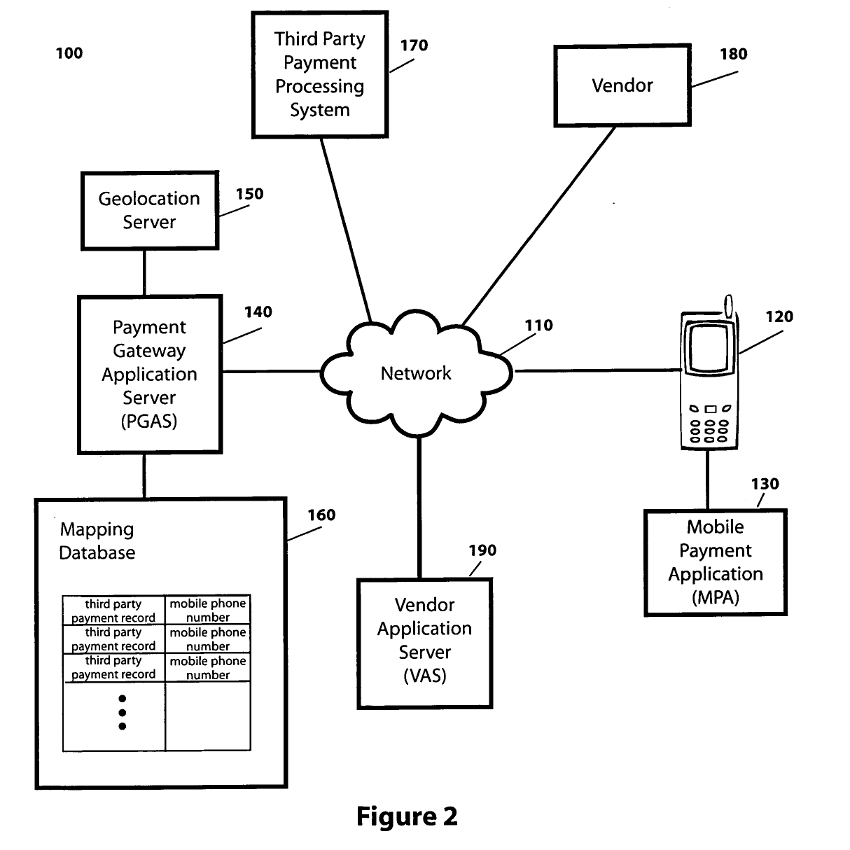

As shown in FIG. 1, mobile phone 120 having an application 130 is connected to a network 110 in a way known in the prior art. Also connected to network 110 is a payment gateway application server (PGAS). When a payer chooses to use mobile phone 120 to make a payment transaction, the application causes the mobile phone number and payment transaction information to be encrypted and transmitted over network 110 to PGAS 140 in a way that will be explained in more detail with reference to FIG. 2. The payment application can also send the current geolocation of the mobile phone to PGAS 140 if the mobile phone is equipped with this capability.

Upon receiving the information from network 110, PGAS 140 uses the mobile phone number to retrieve a third party payment record from mapping database 160. The third party payment record includes information required to complete a transaction with any desired third party payment system, including credit cards, debit cards, PayPal, the payer's phone service account and any other system by which a payer can make payments for goods and services. The information in the third party payment record can include account numbers, proprietary communication protocol information and other data required to complete the payment transaction.

PGAS 140 also compares the current geolocation of mobile phone 120 with the location of the vendor requiring payment as well as with locations that the payer has previously entered as “safe zones.” Safe zones can be, for example, the payer's home or work place although any desired location may be saved by the payer as a location where the mobile phone may be safely used to complete a payment transaction. The current geolocation is either received from the mobile phone, or is retrieved using geolocation server GS 150 of FIGS. 1 and 2.

If the mobile phone 120 is in an approved location, PGAS 140 completes the transaction using the information from the third party payment record to interface with Third Party Payment Processing System 170, such as credit/debit card processors, PayPal, etc.

If mobile phone 120 is not in an approved location, PGAS 140 requests additional verification from the payer via mobile phone 120. The additional verification can include, for example, a personal identification number (PIN), a zip code, mother's maiden name, or other details as understood in the prior art. Upon successful entry of the additional verification, the transaction will be completed, otherwise an error message will be sent to the payer and vendor.

The interaction between a payer using mobile phone 120 to make a payment and a vendor receiving the payment is described in connection with FIG. 2. Elements repeated from FIG. 1 have the same reference numerals. Apparatus 100 can also include a vendor connected to network 110 in a way understood in the prior art. When vendor 180 has processed a transaction and is ready to request payment from the payer, vendor 180 communicates with vendor application server (VAS) 190. VAS 190 can be located on the network, as shown in FIG. 2, included as part of PGAS 140 or it may be incorporated with the payment apparatus at the vendor's location. Vendor 180 sends information comprising at least a transaction amount to VAS 190. The vendor may also send additional information including its geolocation, a timestamp and a description of the items purchased.

In one embodiment VAS 190 generates a two dimensional code which is transmitted back to vendor 180, who then displays it for the payer. The code can be displayed, for example, on a cash register or printed on a receipt. If the payer is using a laptop or other computing device to make a purchase, the code can be displayed on the screen. The payer scans the code which launches Mobile Payment Application MPA 130. The two dimensional code can be, for example, a quick response (QR) code or any other type of code capable of carrying the required amount of information.

In another embodiment, for use with mobile phones without a camera, VAS 190 generates a message which is sent to mobile phone 120 via multi-media messaging service (MMS), short messaging service (SMS) or any preferred messaging protocol. Upon receiving the message, mobile phone 120 launches MPA 130.

A number of communication protocols and data formats can be used to communicate between the various components of FIGS. 1 and 2. These include, for example, hypertext transfer protocol (HTTP), hypertext markup language (HTML), MMS, SMS, extensible markup language (XML) and proprietary protocols used by third party payment systems. Additionally, sensitive information can be encrypted prior to transfer as understood in the prior art.

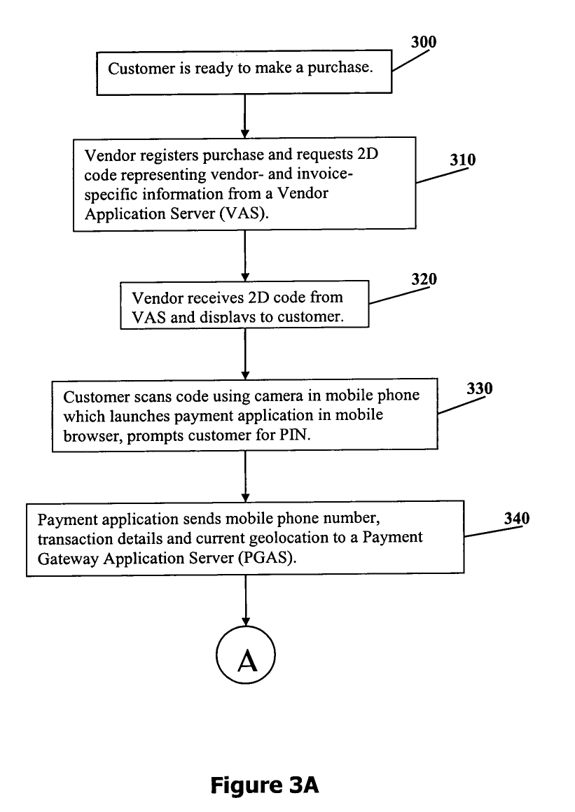

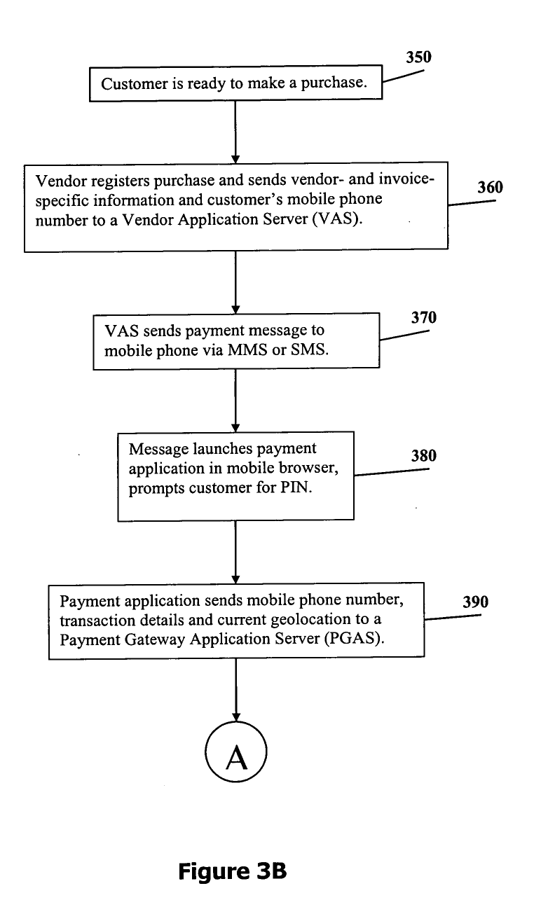

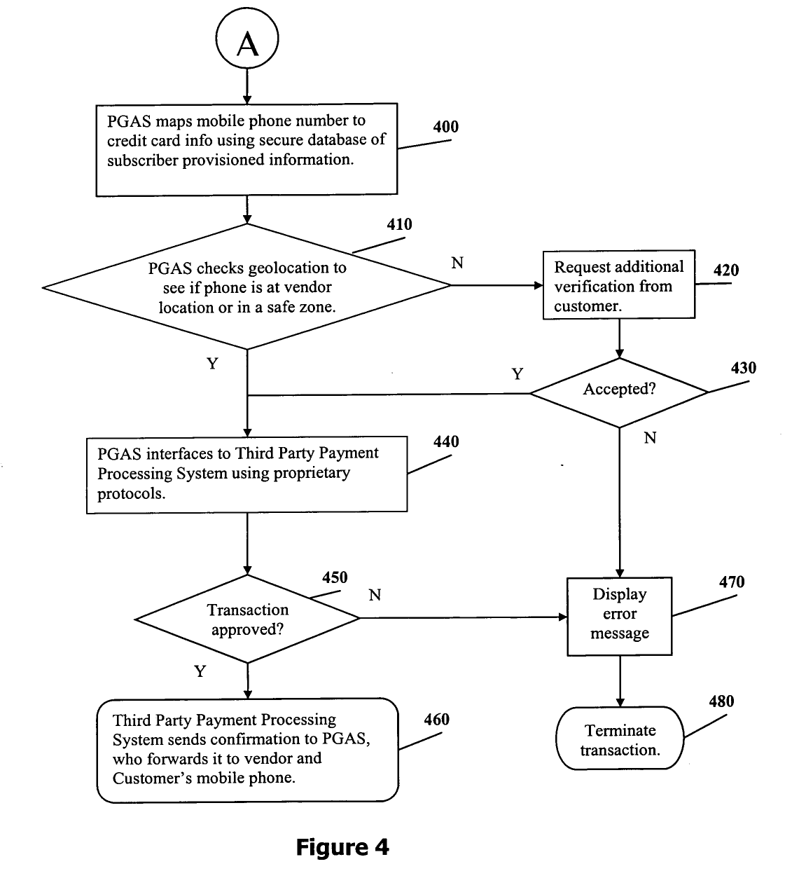

An illustrative description of operation of the apparatus 100 is presented in FIGS. 3A, 3B and 4, for explanatory purposes.

FIG. 3A illustrates the operation of apparatus 100 when the mobile phone used by a payer to make a payment has a camera. In a first step 300, a payer is ready to make a purchase. This purchase could be made in any location including, but not limited to, a retail store, restaurant, or entertainment venue as well as on a network-connected computing device or any other location where a credit or debit card would be used.

In step 310, a vendor requests a two-dimensional code containing information about the purchase from the vendor application server (VAS) 190 shown in FIG. 2. Information embedded in the code includes at least a transaction amount. It can also include an identification and location of the vendor, a timestamp and a description of the purchase. The vendor may communicate with VAS 190 over network 110, a private network local to the vendor or VAS 190 may be located in or near a cash register or other payment device used by the vendor.

In step 320, VAS 190 transfers the code to the vendor who then displays it to the payer. This step could occur in a number of different ways. For example, at a retail store, this step could occur after purchases have been totaled on a cash register and the code could either be printed or displayed on a screen of the cash register. Likewise, at a restaurant the two-dimensional code could be printed on a receipt for the meal. If a payer was shopping online using a network-connected device, the two-dimensional code could be displayed on the screen of the device.

In step 330, the payer uses the mobile phone to scan the two-dimensional code, which launches a payment application, (MPA 130 of FIG. 1). The payment application can be configured by the payer to authorize the transaction with a personal identification number (PIN) or other information depending on the location of the phone, as explained further below.

In step 340, the payment application sends the mobile phone number and transaction details from the two-dimensional code to a Payment Gateway Application server (PGAS 140 of FIG. 1). The payment application will also send the current geolocation of the mobile phone if the mobile phone is equipped with this capability. The information is encrypted prior to transmission. The remaining steps in the method of using a mobile phone to complete a payment transaction will be described in connection with FIG. 4.

FIG. 3B illustrates the operation of apparatus 100 when the mobile phone used by a payer to make a payment does not have a camera. These steps are similar to those of FIG. 3A with a few differences as explained subsequently. In step 350, a payer is ready to make a purchase, as explained for step 300 of FIG. 3A.

In step 360, a vendor registers the purchase and sends invoice-specific information to VAS 190. This information includes at least a transaction amount, and can also include an identification and location of the vendor, a timestamp and a description of the purchase. Instead of requesting a two-dimensional code, the vendor asks for a payment message to be sent to the mobile phone using multi-media messaging service (MMS) or short message service (SMS). VAS 190 sends this message in step 370 and in response, the mobile phone launches a payment application in step 380. The payment application can be flexibly configured by the payer to authorize the transaction with a personal identification number (PIN) or other information. The payment application sends the mobile phone number, transaction details and current geolocation of the mobile phone to PGAS 140 as in step 340 of FIG. 3A.

The rest of the operation of apparatus 100 will be explained with reference to FIG. 4. The steps of FIG. 4 are the same regardless of whether or not the mobile phone has a camera.

In step 400 of FIG. 4, after receiving the encrypted information from the mobile phone in steps 340 or 390, PGAS 140 maps the mobile phone number to a third party payment record using mapping database 160 of FIG. 1.

In step 410, PGAS 140 compares the current geolocation of the mobile phone to the vendor location as well as one or more “safe zones” defined by the payer. The current geolocation is either received from the mobile phone, or is retrieved using geolocation server GS 150 of FIGS. 1 and 2. These safe zones can include the payer's home and work place, for example. PGAS 140 may also check a PIN entry if the payer's mobile phone is configured to require a PIN for all transactions. The mobile phone can be flexibly configured to require the entry of a PIN during all payment transactions, or only those that occur outside a safe zone.

If the mobile phone is not in any of the known secure locations, PGAS 140 requests additional verification from the payer in step 420. If the phone is in a known secure location or if the additional verification is accepted in step 430, the method proceeds to step 440.

In step 440, PGAS 140 interfaces to the appropriate third party payment processing system to complete the payment transaction. If the transaction completes successfully in step 450, a confirmation is sent to PGAS 140 in step 460, which then forwards it to the vendor and the payer's mobile phone.

If the transaction is not completed successfully or the additional verification is not accepted, an error message is displayed in step 470 and the transaction is terminated in step 480.

The preceding method has been described wherein the “intelligence” for executing the method resides in network components. In another embodiment, this intelligence can reside in the mobile phone itself. Additionally, it is possible for the various elements to be distributed in a variety of ways between network components, vendor hardware and the mobile phone.

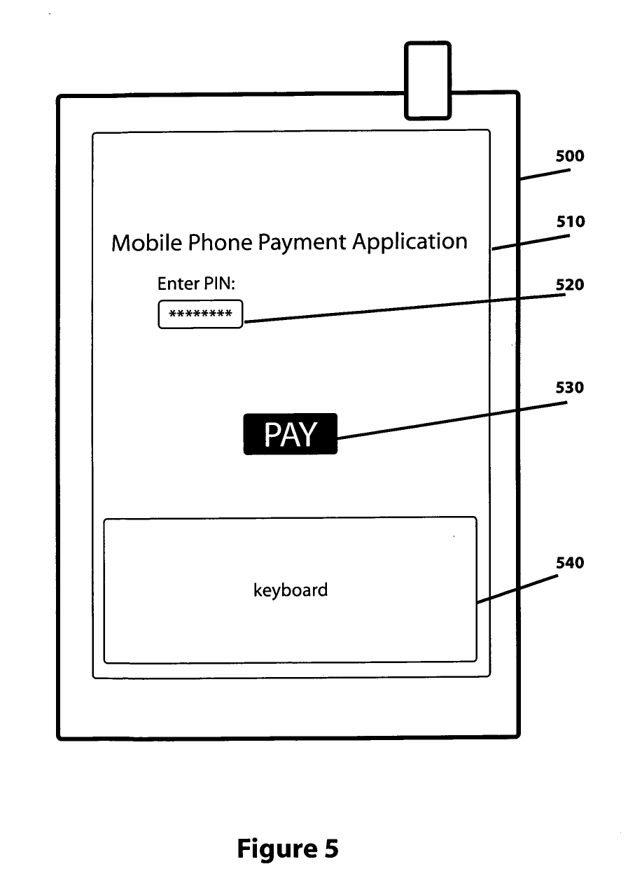

In another embodiment, the mobile phone is a smart phone running a payment application as shown in FIG. 5. Mobile phone 500 in FIG. 5 is shown as a touch screen phone, but any suitable phone with display and input devices could be used. Mobile phone 500 includes a display 510 that displays several components of Mobile phone Payment Application (MPA) 130. These components include a PIN entry area 520, a payment button 530 and a keyboard 540 for entering required information.

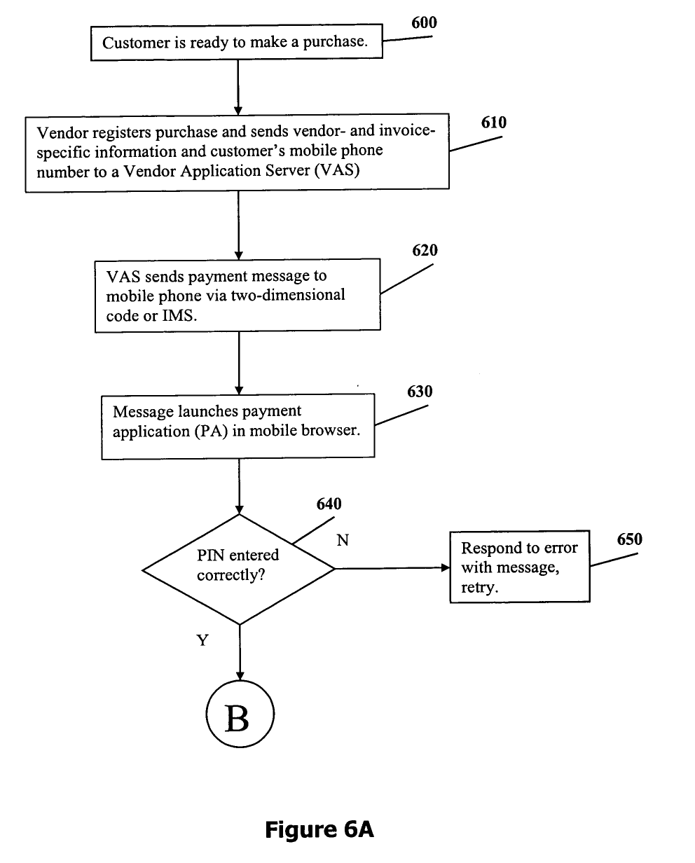

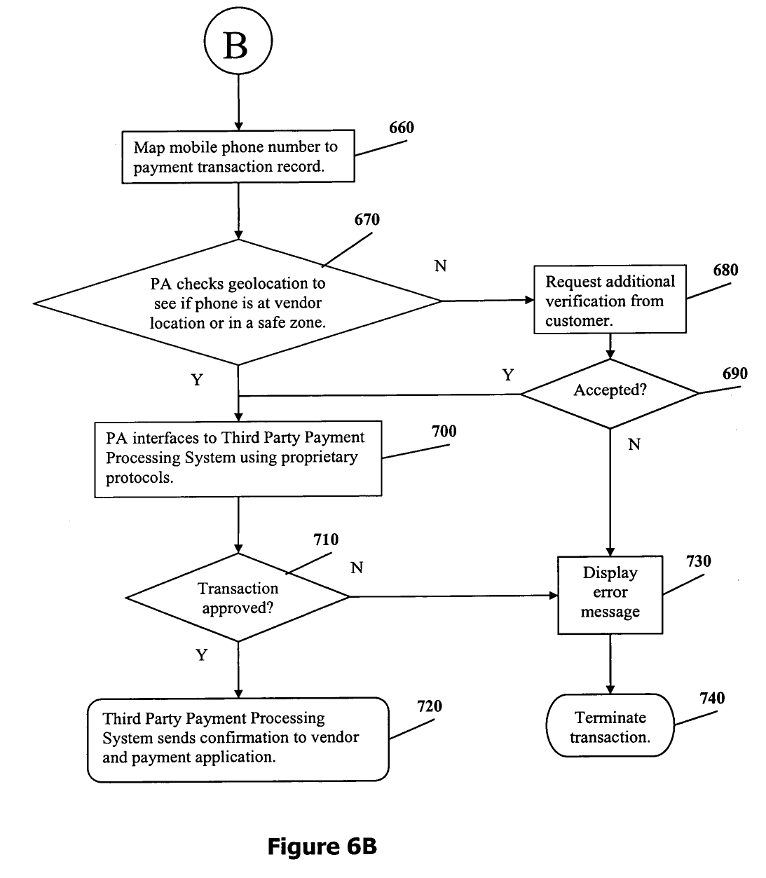

The operation of a mobile phone of FIG. 5 is shown in FIGS. 6A and 6B. In step 600, a payer is ready to make a purchase. This purchase could be made in any location, including but not limited to a retail store, restaurant, or entertainment venue as well as on a network-connected computing device or any other location where a credit or debit card would be used.

In step 610, the vendor registers the purchase and sends vendor- and invoice-specific information to VAS 190. This information includes at least a transaction amount and can also include an identification and location of the vendor, a timestamp and a description of the purchase. In step 620, VAS 190 sends a payment message to the mobile phone. This can be done via a two-dimensional code as explained above for FIG. 3A or via a MMS or SMS message as explained for FIG. 3B.

Regardless of how the payment message is received by the mobile phone, in step 630 it launches the payment application in the mobile phone. The payment application can be flexibly configured by the payer to prompt entry of a personal identification number (PIN) to authorize the transaction. For example, the payer may choose to require a PIN entry for every payment transaction, or only for transactions that occur outside a safe zone. If PIN entry is required, in step 640, the PIN entry is checked, with an incorrect entry prompting a message for retrying as known in the art, shown in step 650.

With a correct PIN entry, the method moves on to FIG. 6B and step 660, where the payment application accesses a third party payment record in the phone. The third party payment record includes information required to complete a transaction with any desired payment system, including credit cards, debit cards, PayPal, the payer's phone service account and any other system by which a payer can make payments for goods and services. The information in the third party payment record can include account numbers, proprietary communication protocol information and other data required to complete the payment transaction.

Next, in step 670, the application compares the current geolocation of the mobile phone to the vendor location as well as one or more “safe zones” defined by the payer. These safe zones can include the payer's home and work place, for example.

If the mobile phone is not in any of the known secure locations, the payment application requests additional verification from the payer in step 680. If the phone is in a known secure location or if the additional verification is accepted in step 690, the payment application moves on to step 700, where it interfaces to the appropriate Third Party Payment Processing System to complete the payment transaction. If the transaction completes successfully in step 710, a confirmation is returned to the vendor and the payment application step 720, which then forwards it to the vendor and the payer's mobile phone.

If the transaction is not completed successfully or the additional verification is not accepted, an error message is displayed in step 730 and the transaction is terminated in step 740.

In another embodiment, the apparatus and method of FIGS. 5 and 6 can be performed using a mobile phone executing an application in a web browser.

The apparatus 100 in one example comprises a plurality of components such as one or more of hardware components and computer software. A number of such components can be combined or divided in the apparatus 100. An example component of the apparatus 100 employs and/or comprises a set and/or series of computer instructions written in or implemented with any of a number of programming languages, as will be appreciated by those skilled in the art. The apparatus 100 in one example employs one or more computer-readable signal-bearing media. The computer-readable signal-bearing media store software, firmware and/or assembly language for performing one or more portions of one or more embodiments. The computer-readable signal-bearing medium for the apparatus 100 in one example comprise one or more of a magnetic, electrical, optical, biological, and atomic data storage medium. For example, the computer-readable signal-bearing medium comprise floppy disks, magnetic tapes, CD-ROMs, DVD-ROMs, hard disk drives, and electronic memory.

The steps or operations described herein are just for example. There may be many variations to these steps or operations without departing from the spirit of the disclosure. For instance, the steps may be performed in a differing order, or steps may be added, deleted, or modified.

Although example embodiments have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1-5. (canceled)

6. An apparatus for completing a payment transaction by a payer using a network-connectable device, comprising:
a vendor application server (VAS) for receiving payment transaction information from a vendor including at least the transaction amount, and generating a vendor payment request message in the form of a two-dimensional code, said vendor displaying the two-dimensional code to the payer;
a payment application, in the network-connectable device, which is launched by scanning the two dimensional code representing the vendor payment request message with the network-connectable device, said payment application preparing a server payment transaction message;
a payment gateway application server (PGAS) for receiving, from the payment application, the server payment transaction message, a unique identifier associated with the network-connectable device and a current geolocation of the network-connectable device then comparing the current geolocation with at least a vendor location and predetermined locations associated with the payer; and
a mapping database coupled to the PGAS for mapping at least one unique identifier of a network-connectable device to at least one third party payment record;
wherein the PGAS, after a positive comparison, completes the payment transaction by retrieving, from the mapping database, a third party payment record associated with the unique identifier received from the network-connectable device, using the third party payment record to communicate with a third party payment processing system and providing a payment transaction result to the network-connectable device and the vendor.

7. The apparatus of claim 6, wherein, if the network-connectable device is not capable of providing a geolocation, it is obtained from a geolocation server operatively coupled to the payment server.

8. (canceled)

9. (canceled)

10. The apparatus of claim 6 wherein the vendor payment request message comprises a message sent using a multi-media messaging service (MMS) or a short messaging service (SMS).

11. The apparatus of claim 6 wherein, if the current geolocation is not the same as the location of the payment transaction or predetermined locations, the PGAS causes the payment application to prompt the payer to provide verification.

12. The apparatus of claim 6, wherein the predetermined locations include the locations of at least one of a home or a workplace of the payer.

13. A method for completing a payment transaction over a network using a network-connectable device, comprising:
receiving payment transaction information from a vendor;
generating a two-dimensional code representing the info;
displaying the two-dimensional code to the payer;
scanning the two-dimensional code with the network-connectable device to launch a payment application;
sending, by the payment application via the network, receiving, by a payment server, a unique identifier of the network-connectable device, a geolocation of the network-connectable device and a server transaction message comprising at least information representing a transaction between the vendor and a payer using the network-connectable device;
associating the unique identifier with a third party payment record stored in a database operatively coupled to the payment server;
comparing the geolocation of the network-connectable device to at least one of a location of the vendor and a list of predetermined locations associated with the payer; and
completing the payment transaction, in response to a positive comparison, by interfacing with a third party payment processing system over the network.

14. The method of claim 13, further comprising the step of:
running an application in the network-connectable device which receives a vendor transaction message comprising at least information about a transaction between the vendor and a payer and sends the unique identifier, the geolocation and the server transaction message to the payment server.

15. The method of claim 14, wherein said step of running an application further comprises the steps of:
prompting the payer to enter a personal identification number (PIN); and
sending the PIN to the payment server.

16. (canceled)

17. The method of claim 14 further comprising the steps of:
receiving payment transaction information from a vendor;
sending a vendor transaction message to the application using MMS or SMS; and
launching the application in the network-connectable device in response to the vendor transaction message.

18. The method of claim 13, further comprising the step of requesting verification information from the network-connectable device if the current geolocation is not the same as the location of the vendor and the list of predetermined locations associated with the payer.

19. A method for completing a transaction over a network using a network-connectable device, comprising the steps of:
receiving a vendor transaction message comprising at least information representing a transaction between the vendor and a payer using the network-connectable device by scanning, with the network-connectable device, a two-dimensional code generated by the vendor;
sending, by the network-connectable device, a payment transaction request containing at least a geolocation of the network-connectable device;
comparing the geolocation of the network-connectable device to at least one of the vendor location and predetermined locations associated with the payer;
if the comparing step is successful, completing the payment transaction by interfacing with a third party payment processing system over the network; and
if the comparing step is not successful, requesting verification information from the payer using the network-connectable device over the network.

20. (canceled)

21. The method of claim 19 wherein the vendor transaction message is sent and received using a multi-media messaging service (MMS) or a short messaging service (SMS).

22. The method of claim 19 further comprising the step of:
prompting the payer to enter a personal identification number (PIN).
